(19) United States
(12) Patent Application Publication
(10) Pub. No.: US 2014/0089699 A1
(43) Pub. Date: Mar. 27, 2014

(54) POWER MANAGEMENT SYSTEM AND METHOD FOR A PROCESSOR

(71) Applicant: ADVANCED MICRO DEVICES, Sunnyvale, CA (US)

(72) Inventors: James M. O'Connor, Austin, TX (US); Jungseob Lee, Madison, WI (US); Michael Schulte, Austin, TX (US); Srilatha Manne, Portland, OR (US)

(73) Assignee: Advanced Micro Devices, Sunnyvale, CA (US)

(21) Appl. No.: 13/628,720

(22) Filed: Sep. 27, 2012

(51) Int. Cl. G06F 1/26; G06F 1/32

(52) U.S. Cl. 713/322; 713/300

(57) ABSTRACT

The present disclosure relates to a method and apparatus for dynamically controlling power consumption by at least one processor. A power management method includes monitoring, by power control logic of the at least one processor, performance data associated with each of a plurality of executions of a repetitive workload by the at least one processor. The method includes adjusting, by the power control logic following an execution of the repetitive workload, an operating frequency of at least one of a compute unit and a memory controller upon a determination that the at least one processor is at least one of compute-bound and memory-bound based on monitored performance data associated with the execution of the repetitive workload.

### FIELD OF THE DISCLOSURE

The present disclosure is generally related to the field of power management for a computer processor, and more particularly to methods and systems for dynamically controlling power consumption by at least one processor executing one or more workloads.

### BACKGROUND

Computer processors, such as central processing units (CPUs), graphical processing units (GPUs), and accelerated processing units (APUs), are limited in performance by power, computational capabilities, and memory bandwidth. Some processors, such as GPUs, have a parallel architecture for processing large amounts of data using parallel processing units or engines. GPUs process graphics data, such as video and image data, and provide the graphics data for output on a display. In some systems, GPUs are also implemented as general purpose GPUs for performing non-graphical, general-purpose computations traditionally executed by CPUs. In other words, GPUs may process data used for general-purpose computations rather than for producing a pixel or other graphical output. For example, applications or subroutines having large amounts of data may be offloaded to the GPU for processing as data parallel workloads to take advantage of the parallel computing structure of the GPU.

Referring to FIG. 1, an exemplary computing system 10 known to the inventors (but which is not admitted herein as prior art) is illustrated including a graphical processing unit (GPU) 12 and a central processing unit (CPU) 14 operatively coupled together via a communication interface or bus 16. GPU 12 includes a plurality of compute units or engines 18 that cooperate to provide a parallel computing structure. Compute units 18 of GPU 12 are operative to process graphics data as well as general-purpose data used for producing non-graphical outputs.

CPU 14 provides the overarching command and control for computing system 10. For example, CPU 14 executes a main program for computing system 10 and assigns various computing tasks via driver 15 to GPU 12 in the form of workloads. As referenced herein, a workload, or “kernel,” refers to a program, an application, a portion of a program or application, or other computing task that is executed by GPU 12. For example, a workload may include a subroutine of a larger program executed at the CPU 14. The workload often requires multiple or repetitive executions at the GPU 12 throughout the main program execution at CPU 14. GPU 12 functions to perform the data parallel, non-graphical computations and processes on the workloads provided by CPU 14. GPU 12 executes each received workload by allocating workgroups to various compute units 18 for processing in parallel. A workgroup as referenced herein includes a portion of the workload, such as one or more processing threads or processing blocks of the workload, that are executed by a single compute unit 18. Each compute unit 18 may execute multiple workgroups of the workload.

GPU 12 includes a memory controller 30 for accessing a main or system memory 36 of computing system 10. CPU 14 is also configured to access system memory 36 via a memory controller (not shown). GPU 12 further includes a power supply 38 that receives power from a power source of computing system 10 for consumption by components of GPU 12. Compute units 18 of GPU 12 temporarily store data used during workload execution in cache memory 20. GPU 12 further includes one or more clock generators 22 that are tied to the components of GPU 12 for dictating the operating frequency of the components of GPU 12.

A command/control processor 24 of GPU 12 receives workloads and other task commands from CPU 14 and provides feedback to CPU 14. Command/control processor 24 manages workload distribution by allocating the processing threads or workgroups of each received workload to one or more compute units 18 for execution. A power management controller 26 of GPU 12 controls the distribution of power from power supply 38 to on-chip components of GPU 12. Power management controller 36 may also control the operational frequency of on-chip components.

In traditional computing systems such as computing system 10 of FIG. 1, GPU 12 may become compute-bound (i.e., limited in performance by the processing capabilities of compute units 18) or memory-bound (i.e., limited in performance by the memory bandwidth capabilities of memory controller 30 and system memory 36) during workload execution depending on the characteristics of the executed workload. The speed at which GPU 12 executes computations is tied to the configuration and capabilities of the compute units 18, cache memories 20, device memory 32, and component interconnections. For example, GPU 12 becomes compute-bound when one or more components (e.g., compute units 18) of the GPU 12 is unable to process data fast enough to meet the demands of other components of GPU 12 (e.g., memory controller 30) or of CPU 14, resulting in a processing bottleneck where other GPU components (e.g., memory controller 30) or components external to GPU 12 (e.g., system memory 36 or CPU 14) wait on compute units 18 of GPU 12 to complete its computations. As such, when GPU 12 is compute-bound, additional memory bandwidth of memory controller 30, for example, is available but unused while memory controller 30 waits on compute units 18 to complete computations. Memory-bound refers to the bandwidth limitations between memory controller 30 of GPU 12 and external system memory 36. For example, GPU 12 is memory-bound when a bottleneck exists in communication between memory controller 30 and system memory 36, resulting in other GPU components (e.g., compute units 18) waiting on memory controller 30 to complete its read/write operations before further processing can proceed. Such a bottleneck may be due to a process or data overload at one or more of the memory controller 30, system memory 36, and memory interface 34. A memory-bound condition may also arise when insufficient parallelism exists in the workload, and the compute units 18 remain idle with no other available work to execute while waiting on the latency of the memory subsystem (e.g., controller 30, memory 36, and/or interface 34). As such, compute units 18 may be in a stalled condition while waiting on memory controller 30 to complete read/writes with system memory 36.

When GPU 12 is compute-bound or memory-bound, portions of GPU 12 may be in an idle or stalled condition wherein they continue to operate at full power and frequency while waiting on processing to complete in other portions of the chip (compute-bound) or while waiting on data communication with system memory 36 to complete at memory controller 30 (memory-bound). As such, some traditional methods have been implemented to help reduce the power consumption of GPU 12 in such scenarios where one or more components or logic blocks of GPU 12 are idle or stalled and do not require full operational power and frequency. These traditional methods include clock gating, power gating, power sloshing, and temperature sensing.

Clock gating is a traditional power reduction technique wherein when a logic block of GPU is idle or disabled, the associated clock signal to that portion of logic is disabled to reduce power. For example, when a compute unit 18 and/or its associated cache memory 20 is idle, the clock signal (from clock generator(s) 22) to that compute unit 18 and/or cache 20 is disabled to reduce power consumption that is expended during transistor switching. When a request is made to the compute unit 18 and/or cache 20, the clock signal is enabled to allow execution of the request and disabled upon completion of the request execution. A control signal or flag may be used to identify which logic blocks of GPU 12 are idle and which logic blocks are functioning. As such, clock gating serves to reduce the switching power that is normally expended (i.e., from transistor switching) when an idle or disabled portion of GPU 12 continues to receive a clock input.

Power gating is a traditional power reduction technique wherein power (i.e., from power supply 38) to a portion of GPU logic is removed when that portion of GPU logic is idle or disabled. Power gating serves to reduce the leakage power that is typically expended when an idle or disabled logic block of GPU 12 remains coupled to a power supply. Some portions of GPU 12 may be power gated while other portions of GPU 12 are clock gated to reduce both overall leakage power and switching power of the GPU 12.

Dynamic Voltage and Frequency Scaling (DVFS) is a traditional power management technique involving the adjustment or scaling of the voltage and frequency of processor cores (e.g., CPU or GPU cores) to meet the different power demands of each processor or core. In other words, the voltage and/or operating frequency of the processor or core is either decreased or increased depending on the operational demands of that processor or core. DVFS may involve increasing or decreasing the voltage/frequency in one or more processors or cores. The reduction of the voltage and frequency of one or more processor components serves to reduce the overall power consumption by those components, while the increase in voltage and frequency serves to increase the performance and power consumption of those components. In traditional systems, DVFS is implemented by determining, during system runtime, which CPU/GPU cores will require more or less power during runtime.

Power sloshing is a more recent power management technique involving the relative adjustment or scaling of the voltage and frequency of processor or GPU cores to rebalance the relative performance and power consumption of these cores within a system. In other words, if one or more GPU/processor cores in a system are currently underutilized, the voltage and/or operating frequency of a processor or GPU core can be decreased. The power savings from this reduction can enable the voltage and frequency of one or more of the highly utilized GPU/processor cores in the system to be increased. The net result is an increase in overall system performance in a fixed power budget by directing the power to the processor/GPU cores most in need of additional performance. In traditional systems, power sloshing is implemented by determining, during system runtime, which CPU/GPU cores will require more or less power.

In some computing systems 10, an on-chip temperature sensor (not shown) is used to detect when a chip component is too hot. For example, when the temperature of a component of GPU 12 reaches a threshold temperature, the power to that component may be reduced, i.e., by reducing the voltage and/or frequency of the component.

In traditional computing systems 10 wherein CPU 14 offloads a non-graphical, repetitive workload to GPU 12 for execution by GPU 12, the above power reduction techniques are configured prior to execution of the repetitive workload by GPU 12. For example, a specific workload to be executed on GPU 12 may be known, based on prior experimentation, to require more power to compute units 18 and less power to memory controller 30, and thus power management controller 26 may be programmed prior to runtime to implement a certain power configuration for that specific workload. However, the memory and computational requirements vary for different workloads depending on workload size and complexity. As such, in order to program GPU 12 with a specific power configuration for each workload prior to workload execution, extensive data collection and experimentation would be required to obtain knowledge of the characteristics and power requirements for each workload. As such, determining and programming a unique power configuration for each workload prior to runtime would require considerable experimentation, time, and effort. Further, traditional computing systems 10 do not provide for the dynamic adjustment of the relative power balance between different subsystems of GPU 12 to tailor the execution resources to each received workload.

Therefore, a need exists for methods and systems to adjust the power configuration of a processor dynamically at runtime. In addition, a need exists for the dynamic adjustment of the relative power balance between different subsystems of the processor to tailor the execution resources to the system's operation. Further, a need exists for performing such power configuration adjustments while satisfying the memory and computational requirements of the system and while minimizing GPU power consumption and/or maximizing performance under a power constraint.

### SUMMARY OF EMBODIMENTS OF THE DISCLOSURE

In an exemplary embodiment of the present disclosure, a power management method is provided for at least one processor having a compute unit and a memory controller. The method includes monitoring, by power control logic of the at least one processor, performance data associated with each of a plurality of executions of a repetitive workload by the at least one processor. The method further includes adjusting, by the power control logic following an execution of the repetitive workload, an operating frequency of at least one of the compute unit and the memory controller upon a determination by the power control logic that the at least one processor is at least one of compute-bound and memory-bound based on monitored performance data associated with the execution of the repetitive workload.

Among other advantages in certain embodiments, the method and system of the present disclosure provides adaptive power management control of one or more processing devices during runtime based on monitored characteristics associated with the repeated execution of a repetitive workload. The repetitive workload may include a single workload that is executed multiple times or multiple workloads that have similar workload characteristics. As such, the method and system serve to minimize or reduce power consumption while minimally affecting performance or to maximize performance under a power constraint. Other advantages will be recognized by those of ordinary skill in the art.

In another exemplary embodiment of the present disclosure, a power management method is provided for at least one processor having a compute unit and a memory controller. The method includes monitoring, by power control logic of the at least one processor, performance data associated with each of a plurality of executions of a repetitive workload by the at least one processor. The method further includes determining, by the power control logic, a percentage of a total workload execution time of a first execution of the repetitive workload that at least one of a write module, a load module, and an execution module of the compute unit is in a stalled condition based on performance data associated with the first execution of the repetitive workload. The method further includes adjusting, by the power control logic prior to a second execution of the repetitive workload, an operating frequency of at least one of the compute unit and the memory controller based on a comparison of the determined percentage with a threshold percentage.

In yet another exemplary embodiment of the present disclosure, an integrated circuit is provided including at least one processor having a memory controller and a compute unit in communication with the memory controller. The at least one processor includes power control logic operative to monitor performance data associated with each of a plurality of executions of a repetitive workload by the at least one processor. The power control logic is further operative to adjust, following an execution of the repetitive workload by the at least one processor, an operating frequency of at least one of the compute unit and the memory controller upon a determination by the power control logic that the at least one processor is at least one of compute-bound and memory-bound based on monitored performance data associated with the execution of the repetitive workload.

In still another exemplary embodiment of the present disclosure, an integrated circuit is provided including at least one processor having a memory controller and a compute unit in communication with the memory controller. The compute unit includes a write module, a load module, and an execution module. The at least one processor includes power control logic operative to monitor performance data associated with each of a plurality of executions of a repetitive workload by the at least one processor. The power control logic is further operative to determine a percentage of a total workload execution time of a first execution of the repetitive workload that at least one of the write module, the load module, and the execution module of the compute unit is in a stalled condition based on performance data associated with the first execution of the repetitive workload. The power control logic is further operative to adjust, prior to a second execution of the repetitive workload, an operating frequency of at least one of the compute unit and the memory controller based on a comparison of the determined percentage with a threshold percentage.

In another exemplary embodiment of the present disclosure, a non-transitory computer-readable medium is provided. The computer-readable medium includes executable instructions such that when executed by at least one processor cause the at least one processor to monitor performance data associated with each of a plurality of executions of a repetitive workload by the at least one processor. The executable instructions when executed further cause the at least one processor to adjust, following an execution of the repetitive workload by the at least one processor, an operating frequency of at least one of the compute unit and the memory controller upon a determination by the power control logic that the at least one processor is at least one of compute-bound and memory-bound based on monitored performance data associated with the execution of the repetitive workload.

In yet another exemplary embodiment of the present disclosure, an apparatus is provided including a first processor operative to execute a program and to offload a repetitive workload associated with the program for execution by another processor. The apparatus further includes a second processor in communication with the first processor and operative to execute the repetitive workload. The second processor includes a memory controller and a compute unit in communication with the memory controller. The compute unit includes a write module, a load module, and an execution module. The second processor includes power control logic operative to monitor performance data associated with each of a plurality of executions of a repetitive workload by the at least one processor. The power control logic is further operative to determine a percentage of a total workload execution time of a first execution of the repetitive workload that at least one of the write module, the load module, and the execution module of the compute unit is in a stalled condition based on performance data associated with the first execution of the repetitive workload. The power control logic is further operative to adjust, prior to a second execution of the repetitive workload, an operating frequency of at least one of the compute unit and the memory controller based on a comparison of the determined percentage with a threshold percentage.

### BRIEF DESCRIPTION OF THE DRAWINGS

The invention will be more readily understood in view of the following description when accompanied by the below figures and wherein like reference numerals represent like elements:

FIG. 1 is a block diagram of a computing system known by the inventors including a graphical processing unit (GPU) and a central processing unit (CPU);

FIG. 2 is a block diagram of a computing system in accordance with an embodiment of the present disclosure including power control logic for managing and controlling power consumption by the GPU during execution of a repetitive workload;

FIG. 3 is a block diagram of an exemplary compute unit of the GPU of FIG. 2;

FIG. 4 is a flow chart of an exemplary method of operation of the power control logic of FIG. 2 for managing processor power consumption;

FIG. 5 is a flow chart of another exemplary method of operation of the power control logic of FIG. 2 for managing processor power consumption;

FIG. 6 is a flow chart of an exemplary method of operation of the power control logic of FIG. 2 for activating compute units;

FIG. 7 is a flow chart of an exemplary power management method of the power control logic of FIG. 2 for reducing power consumption by the GPU;

FIG. 8 is a flow chart of another exemplary method of operation of the power control logic of FIG. 2 for activating compute units; and

FIG. 9 is a flow chart of another exemplary power management method of the power control logic of FIG. 2 for improving GPU performance under a known power constraint.

### DETAILED DESCRIPTION

The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the embodiments, various logic may be implemented in any appropriate fashion and would remain in accordance with the embodiments herein disclosed.

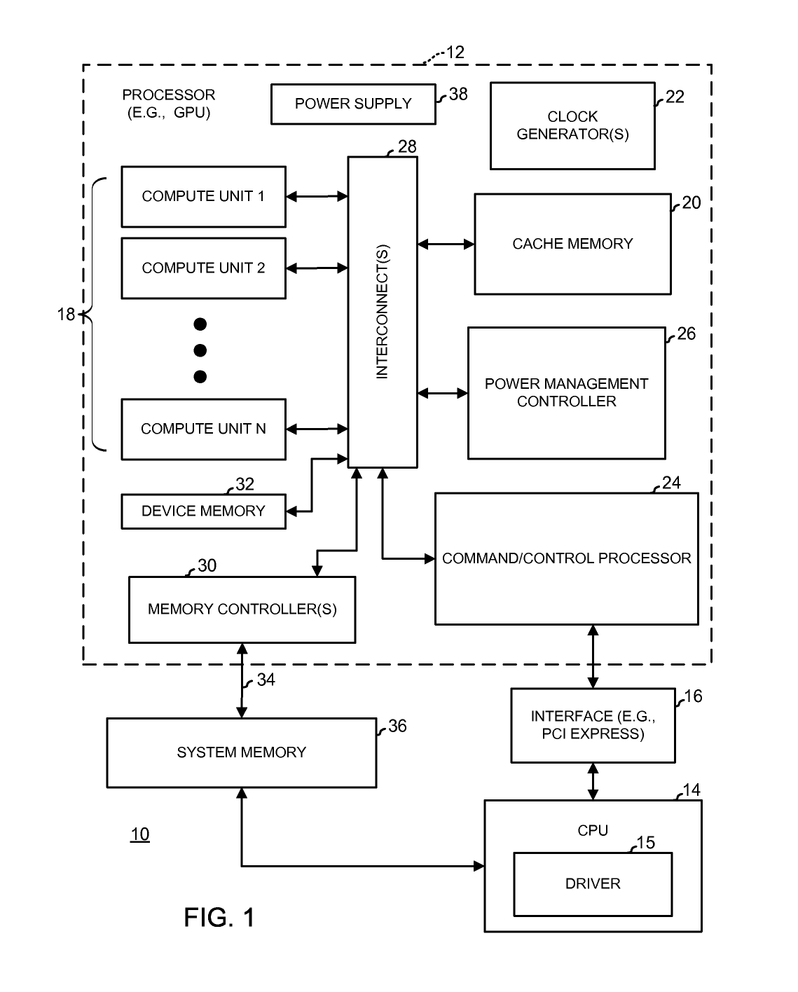

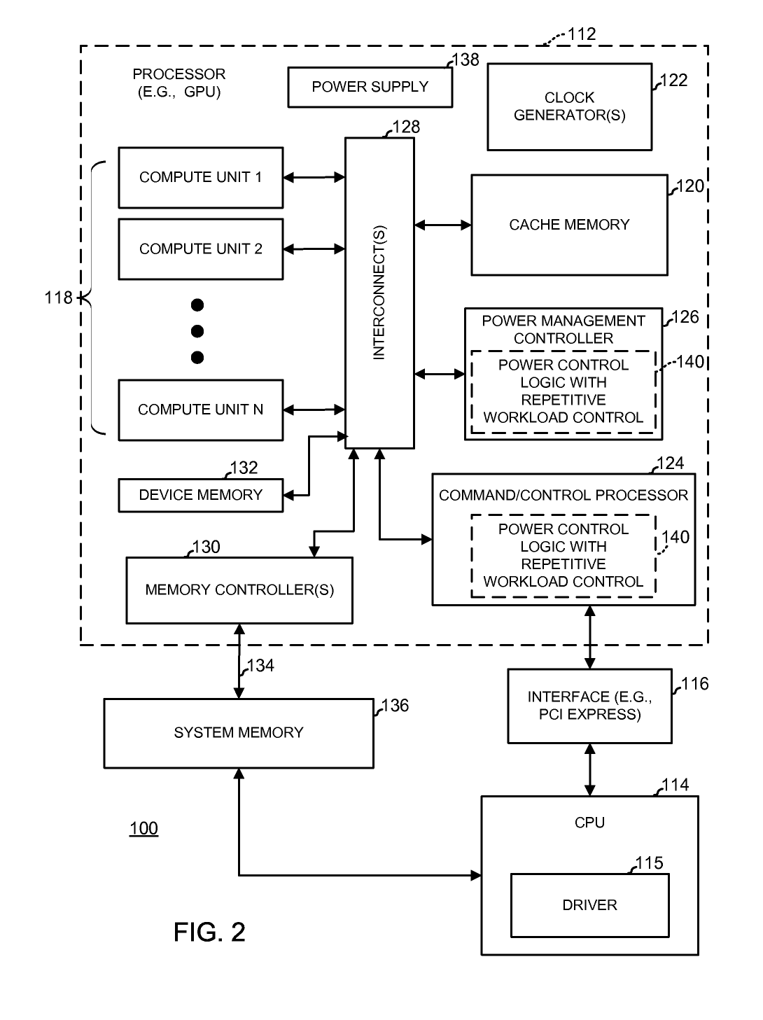

FIG. 2 illustrates an exemplary computing system 100 according to various embodiments that is configured to dynamically manage power consumption by GPU 12. Computing system 100 may be viewed as modifying the known computing system 10 described in FIG. 1. For example, GPU 112 of FIG. 2 may be viewed as a modification of the GPU 12 of FIG. 1, and CPU 114 of FIG. 2 may be viewed as a modification of the CPU 14 of FIG. 1. Like components of computing system 10 of FIG. 1 and computing system 100 of FIG. 2 are provided with like reference numbers. Various other arrangements of internal and external components and corresponding connectivity of computing system 100, that are alternatives to what is illustrated in the figures, may be utilized and such arrangements of internal and external components and corresponding connectivity would remain in accordance with the embodiments herein disclosed.

Referring to FIG. 2, an exemplary computing system 100 is illustrated that incorporates the power control logic 140 of the present disclosure. Computing system 100 includes GPU 112 and CPU 114 coupled together via a communication interface or bus 116. Communication interface 116, illustratively external to GPU 112 and CPU 114, communicates data and information between GPU 112 and CPU 114. Interface 116 may alternatively be integrated with GPU 112 and/or with CPU 114. An exemplary communication interface 116 is a Peripheral Component Interconnect (PCI) Express interface 116. GPU 112 and CPU 114 are illustratively separate devices but may alternatively be integrated as a single chip device. GPU 112 includes a plurality of compute units or engines 118 that cooperate to provide a parallel computing structure. Any suitable number of compute units 118 may be provided. Compute units 118 of GPU 112 are illustratively operative to process graphics data as well as general purpose, non-graphical data. Compute units 118 are illustratively single instruction multiple data (SIMD) engines 118 operative to execute multiple data in parallel, although other suitable compute units 118 may be provided. Compute units 118 may also be referred to herein as processing cores or engines 118. In an alternative embodiment, GPU 112 includes several interconnected multiprocessors each comprised of a plurality of compute units 118.

CPU 114 provides the overarching command and control for computing system 100. In one embodiment, CPU 114 includes an operating system for managing compute task allocation and scheduling for computing system 100. The operating system of CPU 114 executes one or more applications or programs, such as software or firmware stored in memory external or internal to CPU 114. As described herein with CPU 14 of FIG. 1, CPU 114 offloads various computing tasks associated with an executed program to GPU 112 in the form of workloads. CPU 114 illustratively includes a driver 115 (e.g., software) that contains instructions for driving GPU 112, e.g., for directing GPU to process graphical data or to execute the general computing, non-graphical workloads. In one embodiment, the program executed at CPU 14 instructs driver 115 that a portion of the program, i.e., a workload, is to be executed by GPU 112, and driver 115 compiles instructions associated with the workload for execution by GPU 112. In one embodiment, CPU 114 sends a workload identifier, such as a pointer, to GPU 112 that points to a memory location (e.g., system memory 136) where the compiled workload instructions are stored. Upon receipt of the identifier, GPU 112 retrieves and executes the associated workload. Other suitable methods may be provided for offloading workloads from CPU 114 to GPU 112. GPU 112 functions as a general purpose GPU 112 by performing the non-graphical computations and processes on the workloads provided by CPU 114. As with GPU 12 of FIG. 1, GPU 112 executes each received workload by allocating workgroups to various compute units 118 for processing in parallel. Each compute unit 118 may execute one or more workgroups of a workload.

System memory 136 is operative to store programs, workloads, subroutines, etc. and associated data that are executed by GPU 112 and/or CPU 114. System memory 136, which may include a type of random access memory (RAM), for example, includes one or more physical memory locations. System memory 136 is illustratively external to GPU 112 and accessed by GPU 112 via one or more memory controllers 130. While memory controller 130 is referenced herein as a single memory controller 130, any suitable number of memory controllers 130 may be provided for performing read/write operations with system memory 136. As such, memory controller 130 of GPU 12, illustratively coupled to system memory 136 via communication interface 134 (e.g., a communication bus 134), manages the communication of data between GPU 112 and system memory 136. CPU 114 may also include a memory controller (not shown) for accessing system memory 136.

GPU 112 includes an interconnect or crossbar 128 to connect and to facilitate communication between the components of GPU 112. While only one interconnect 128 is shown for illustrative purposes, multiple interconnects 128 may be provided for the interconnection of the GPU components. GPU 112 further includes a power supply 138 that provides power to the components of GPU 112.

Compute units 118 of GPU 112 temporarily store data used during workload execution in cache memory 120. Cache memory 120, which may include instruction caches, data caches, texture caches, constant caches, and vertex caches, for example, includes one or more on-chip physical memories that are accessible by compute units 118. For example, in one embodiment, each compute unit 118 has an associated cache memory 120, although other cache configurations may be provided. GPU 112 further includes a local device memory 121 for additional on-chip data storage.

A command/control processor 124 of GPU 112 communicates with CPU 114. In particular, command/control processor 124 receives workloads (and/or workload identifiers) and other task commands from CPU 114 via interface 116 and also provides feedback to CPU 114. Command/control processor 24 manages workload distribution by allocating the workgroups of each received workload to one or more compute units 118 for execution. A power management controller 126 of GPU 112 is operative to control and manage power allocation and consumption of GPU 112. Power management controller 126 controls the distribution of power from power supply 138 to on-chip components of GPU 112. Power management controller 126 and command/control processor 124 may include fixed hardware logic, a microcontroller running firmware, or any other suitable control logic. In the illustrated embodiment, power management controller 126 communicates with command/control processor 124 via interconnect(s) 128.

GPU 112 further includes one or more clock generators 122 that are tied to the components of GPU 112 for dictating the operating frequency of the components of GPU 112. Any suitable clocking configurations may be provided. For example, each GPU component may receive a unique clock signal, or one or more components may receive common clock signals. In one example, compute units 118 are clocked with a first clock signal for controlling the workload execution, interconnect(s) 128 and local cache memories 120 are clocked with a second clock signal for controlling on-chip communication and on-chip memory access, and memory controller 130 is clocked with a third clock signal for controlling communication with system memory 136.

GPU 112 includes power control logic 140 that is operative to monitor performance characteristics of an executed workload and to dynamically manage an operational frequency, and thus voltage and power, of compute units 118 and memory controller 130 during program runtime, as described herein. For example, power control logic 140 is configured to communicate control signals to compute units 118 and memory controller 130 and to clock generator 122 to control the operational frequency of each component. Further, power control logic 140 is operative to determine an optimal minimum number of compute units 118 that are required for execution of a workload by GPU 112 and to disable compute units 118 that are not required based on the determination, as described herein. By dynamically controlling the operational frequency and the number of active compute units 118 for a given workload, power control logic 140 is operative to minimize GPU power consumption while minimally affecting GPU performance in one embodiment and to maximize GPU performance under a fixed power budget in another embodiment.

Power control logic 140 may include software or firmware executed by one or more processors, illustratively GPU 112. Power control logic 140 may alternatively include hardware logic. Power control logic 140 is illustratively implemented in command/control processor 124 and power management controller 126 of GPU 112. However, power control logic 140 may be implemented entirely in one of command/control processor 124 and power management controller 126. Similarly, a portion or all of power control logic 140 may be implemented in CPU 114. In this embodiment, CPU 114 determines a GPU power configuration for workload execution, such as the number of active compute units 118 and/or the frequency adjustment of compute units 118 and/or memory controller 30, and provides commands to command/control processor 124 and power management controller 126 of GPU 112 for implementation of the power configuration.

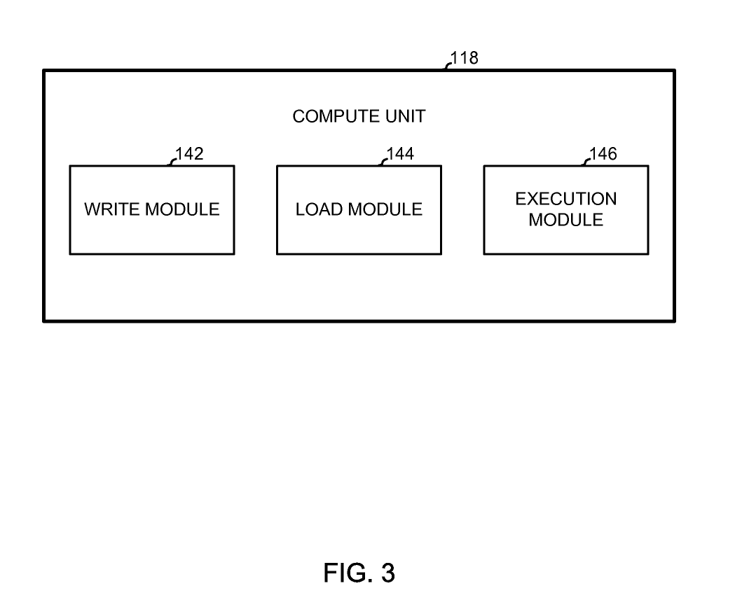

Referring to FIG. 3, an exemplary compute unit 118 of FIG. 2 is illustrated. Compute unit 118 illustratively includes a write module 142, a load module 144, and an execution module 146. Write module 142 is operative to send write requests and data to memory controller 130 of FIG. 2 to write data to system memory 136. Load module 144 is operative to send read requests to memory controller 130 for reading and loading data from system memory 136 to GPU memory (e.g., cache 120). The data loaded by load module 144 includes workload data that is used by execution module 146 for execution of the workload. Execution module 146 is operative to perform computations and to process workload data for execution of the workload. Each of write module 142, load module 144, and execution module 146 may include one or more logic units. For example, execution module 146 may include multiple arithmetic logic units (ALUs) for performing arithmetic and other mathematical and logical computations on the workload data.

Power control logic 140 of FIG. 2 monitors the performance characteristics of GPU 112 during each execution of the workload. In the illustrated embodiment, power control logic 140 monitors performance data by implementing performance counters in one or more compute units 118 and/or memory controller 130. Performance counters may be implemented in other suitable components of GPU 112 to monitor performance characteristics during workload execution, such as in memory (such as memory 132, 136 and cache memory 120) and other suitable components. By tracking performance counters, power control logic 140 determines an activity level and/or utilization of compute units 118 and memory controller 130 and other components. In one embodiment, GPU 112 stores the performance data in device memory 132, although other suitable memories may be used. Power control logic 140 is configured to monitor performance data associated with executions of both repetitive and non-repetitive workloads. In one embodiment, the repetitive workload includes a workload that is executed multiple times or multiple workloads that have similar characteristics.

For example, power control logic 140 may determine based on the performance counters that one or more compute units 118 are stalled for a certain percentage of the total workload execution time. When stalled, the compute unit 118 waits on other components, such as memory controller 130, to complete operations before proceeding with processing and computations. Performance counters for one or more of write module 142, load module 144, and execution module 146 of compute unit 118 may be monitored to determine the amount of time that the compute unit 118 is stalled during an execution of the workload, as described herein. Such a stalled or idle condition of the compute unit 118 when waiting on memory controller 130 indicates that GPU 112 is memory-bound, as described herein. As such, the compute unit 118 operates at less than full processing capacity during the execution of the workload due to the memory bandwidth limitations. For example, a compute unit 118 may be determined to be stalled 40 percent of the total execution time of the workload. A utilization of the compute unit 118 may also be determined based on the performance counters. For example, the compute unit 118 may be determined to have a utilization of 60 percent when executing that workload, i.e., the compute unit 118 performs useful tasks and computations associated with the workload 60 percent of the total workload execution time.

Similarly, power control logic 140 may determine based on the performance counters that memory controller 130 has unused memory bandwidth available during execution of the workload, i.e., that at least a portion of the memory bandwidth of memory controller 130 is not used during workload execution while memory controller 130 waits on the compute unit(s) 118 to complete an operation. Such an underutilization of the full memory bandwidth capacity of memory controller 130 due to memory controller 130 waiting on computations to complete at compute units 118 indicates that GPU 112 is compute-bound, as described herein. For example, power control logic 140 may determine a percentage of the memory bandwidth that is not used during workload execution. Similarly, power control logic 140 may determined the percentage of the total workload execution time that memory controller 130 is inactive, i.e., not performing read/writes with system memory, or that memory controller 130 is underutilized (memory 136, or portions thereof, may also be similarly underutilized). In one embodiment, performance counters for one or more of write module 142, load module 144, and execution module 146 of compute unit 118 may be monitored to determine the underutilization and/or available bandwidth of memory controller 130, as described herein, although performance counters may also be monitored at memory controller 130.

Exemplary performance counters used to monitor workload execution characteristics include the size of the workload (GlobalWorkSize), the size of each workgroup (GroupWorkSize), and the total workload execution time spent by GPU 112 executing the workload (GPUTime). GlobalWorkSize and GroupWorkSize may be measured in bytes, while GPUTime may be measured in milliseconds (ms), for example. In one embodiment, GPUTime does not include the time spent by command/control processor 124 setting up the workload, such as time spent loading the workload instructions and allocating the workgroups to compute units 118, for example. Other exemplary performance counters include the number of instructions processed by execution module 146 per workgroup (ExecInsts), the average number of load instructions issued by load module 144 per workgroup (LoadInsts), and the average number of write instructions issued by write module 142 per workgroup (WriteInsts). Still other exemplary performance counters include the percentage of GPUTime that the execution module 146 is busy (e.g., actively processing or attempting to process instructions/data) (ExecModuleBusy), the percentage of GPUTime that the load module 144 is stalled (e.g., waiting on memory controller 130 or execution module 146) during workload execution (LoadModuleStalled), the percentage of GPUTime that the write module 142 is stalled (e.g., waiting on memory controller 130 or execution module 146) during workload execution (WriteModuleStalled), and the percentage of GPUTime that the load module 144 is busy (e.g., actively issuing or attempting to issue read requests) during workload execution (LoadModuleBusy). In the illustrated embodiment, LoadModuleBusy includes the total percentage of time the load module 144 is active including both stalled (LoadModuleStalled) and not stalled (i.e., issuing load instructions) conditions. For example, a percentage value of 0% for LoadModuleStalled or WriteModuleStalled indicates that the respective load module 144 or write module 142 was not stalled during its entire active state during workload execution. Similarly, a percentage value of 100% for ExecModuleBusy or LoadModuleBusy indicates that the respective execution module 146 or load module 144 was busy (either stalled or executing instructions) during the entire execution of the workload (GPUTime). Other exemplary performance counters include the number of instructions completed by execution module 146 per time period and the depth of the read or write request queues at memory controller 130. Other suitable performance counters may be used to measure and monitor the performance characteristics of GPU components during workload execution.

In the illustrated embodiment, power control logic 140 includes two modes of operation including a power savings mode and a performance mode, although additional operational modes may be provided. In a power savings mode of operation, power control logic 140 dynamically controls power consumption by GPU 112 during runtime of computing system 100 to minimize the energy used by GPU 112 during workload execution while minimally affecting GPU performance. GPU 112 may implement this mode of operation when a limited amount of energy is available, such as, for example, when computing system 100 is operating on battery power, or other suitable configurations when a limited amount of power is available. In a performance mode of operation, power control logic 140 dynamically controls power consumption by GPU 112 during runtime of computing system 100 to maximize GPU performance during workload execution under one or more known performance constraints. The performance constraints include, for example, a maximum available power level provided to GPU 112. GPU 112 may implement this mode of operation when, for example, power supply 138 (FIG. 2) provides a constant power level (e.g., when computing system 100 is plugged into an electrical outlet that provides a fixed power level). The performance constraint may also include a temperature constraint, such as a maximum operating temperature of GPU 112 and/or components of GPU 112.

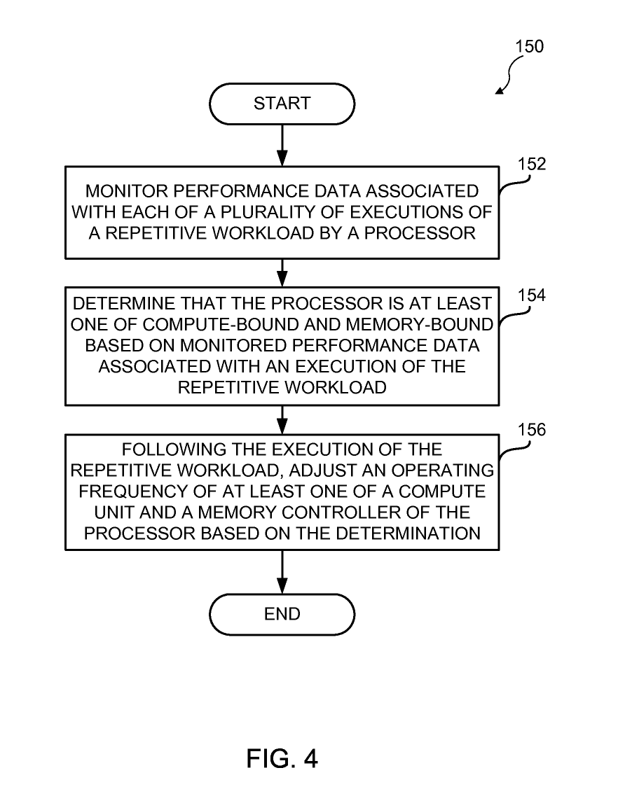

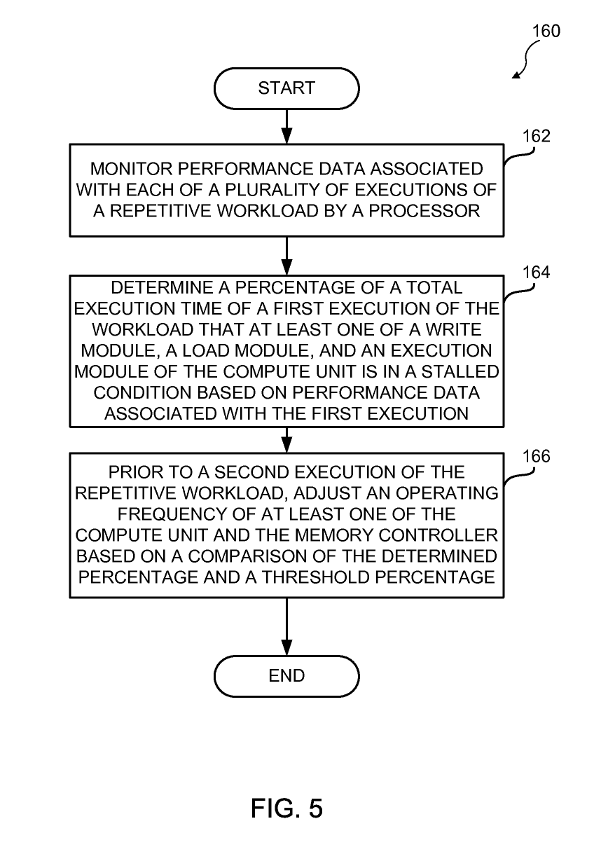

FIGS. 4 and 5 illustrate exemplary power management methods 150, 160 implemented by power control logic 140 of FIG. 2. Reference is made to computing system 100 of FIG. 2 throughout the descriptions of FIGS. 4 and 5. The flow diagrams 150, 160 of FIGS. 4 and 5 are described as being performed by power control logic 140 of command/control processor 124 of GPU 112, although flow diagrams 150, 160 may alternatively be performed by power control logic 140 of power management controller 126 or of CPU 114 or by a combination of power control logic 140 of processor 124, controller 126, and/or CPU 114, as described herein.

Referring to the flow diagram 150 of FIG. 4, power control logic 140 at block 152 monitors performance data associated with each of a plurality of executions of a repetitive workload by at least one processor (e.g., GPU 112). In the illustrated embodiment, the performance data includes a plurality of performance counters implemented at compute units 118 and/or memory controller 130, as described herein. In one embodiment, the repetitive workload is offloaded by CPU 114 and is associated with a main program executed at CPU 114. In one embodiment, the monitoring includes receiving an identifier (e.g., a pointer) from CPU 114 associated with the repetitive workload, and GPU 112 executes the repetitive workload following each receipt of the identifier.

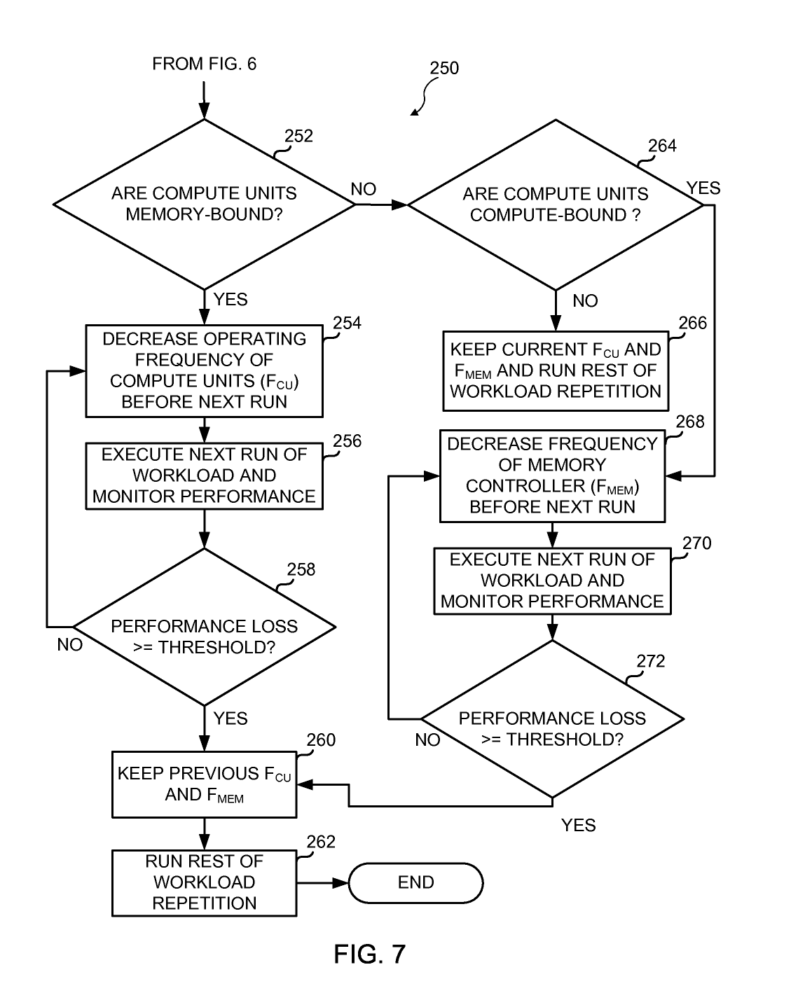

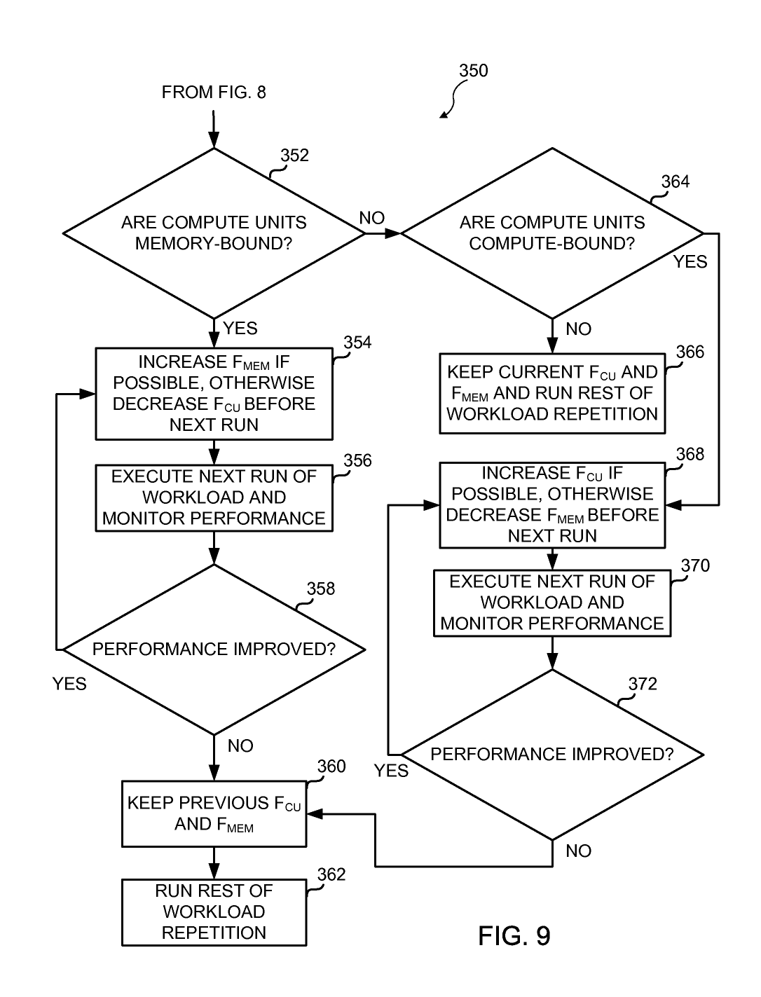

At block 154, power control logic 140 determines the at least one processor (e.g., GPU 112) is at least one of compute-bound and memory-bound based on monitored performance data associated with the execution of the repetitive workload. In one embodiment, GPU 112 is determined to be compute-bound based on memory controller 130 having unused memory bandwidth available or being underutilized for at least a portion of the total workload execution time, and GPU 112 is determined to be memory-bound based on at least one compute unit 118 being in a stalled condition for at least a portion of the total workload execution time, as described herein. In one embodiment, power control logic at block 154 determines a total workload execution time (e.g., GPUTime) associated with the execution of the repetitive workload, determines a percentage of the total workload execution time that at least one of the load module 144 (FIG. 3) and the write module (FIG. 3) of a compute unit 118 is in a stalled condition, and compares the percentage of the total workload execution time to a threshold percentage to determine that the at least one processor is at least one of compute-bound and memory-bound. In one embodiment, the threshold percentage is based on the percentage of the total workload execution time (GPUTime) that the execution module 146 was busy during the workload execution (ExecModuleBusy), as described herein with respect to FIGS. 7 and 9. In one embodiment, the threshold percentage is predetermined (e.g., 30%), as described herein with respect to FIGS. 7 and 9. Other suitable threshold percentages may be implemented at block 154.

At block 156, power control logic 140 adjusts an operating frequency of at least one of the compute unit 118 and the memory controller 130 upon a determination at block 154 that GPU 112 is at least one of compute-bound and memory-bound. In a power savings mode, power control logic 140 reduces the operating frequency of compute unit 118 upon a determination that GPU 112 is memory-bound and reduces the operating frequency of memory controller 130 upon a determination that GPU 112 is compute-bound. In a performance mode, power control logic 140 increases the operating frequency of memory controller 130 upon a determination that GPU 112 is memory-bound and increases the operating frequency of compute unit 118 upon a determination that GPU 112 is compute-bound. In one embodiment, the repetitive workload includes multiple workloads received from CPU 114 that have similar workload characteristics (e.g., workload size, total workload execution time, number of instructions, distribution of types of instructions, etc.). As such, based on the monitored performance data associated with the execution of the similar workloads, power control logic 140 adjusts the operating frequency of at least one of the compute unit 118 and the memory controller 130.

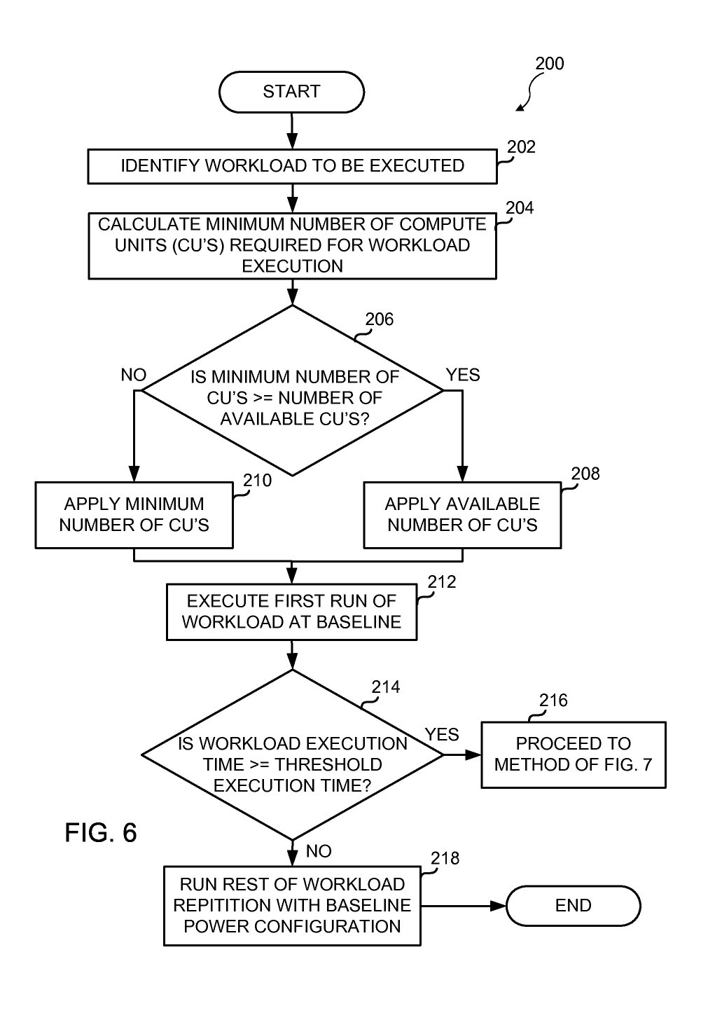

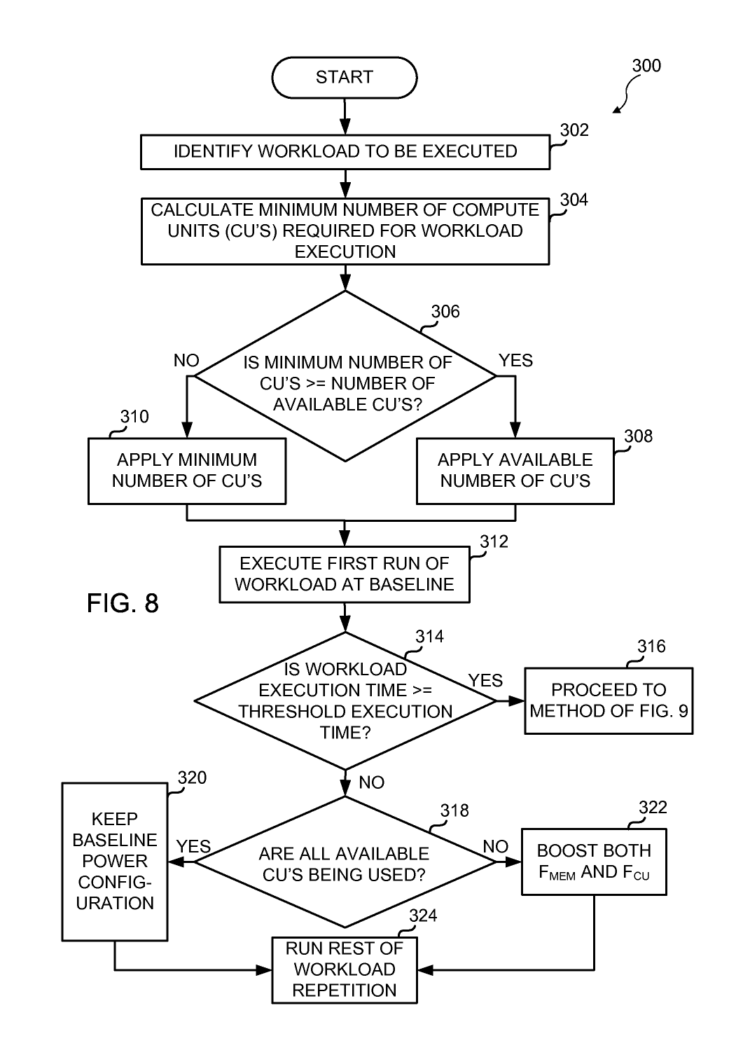

In one embodiment, GPU 112 receives and executes a different workload that has an execution time that is less than a threshold execution time, as described herein with respect to FIGS. 6 and 8. In one embodiment, the GPU 112 executes this workload at a baseline power configuration (e.g., at a maximum operating frequency of the compute units 118 and memory controller 130).

Referring to the flow diagram 160 of FIG. 5, power control logic 140 at block 162 monitors performance data associated with each of a plurality of executions of a repetitive workload by at least one processor (e.g., GPU 112), as described herein with reference to block 152 of FIG. 4. At block 164, power control logic 140 determines a percentage of the total workload execution time of a first execution of the repetitive workload that at least one of write module 142, load module 144, and execution module 146 of compute unit 118 is in a stalled condition based on performance data associated with the first execution of the repetitive workload. In the embodiment described herein, the stalled condition is determined based on performance counters.

At block 166, prior to a second execution of the repetitive workload, power control logic 140 adjusts an operating frequency of at least one of compute unit 118 and memory controller 130 based on a comparison of the percentage determined at block 164 and a threshold percentage. In a power savings mode, power control logic 140 reduces the operating frequency of compute unit 118 upon the percentage of the total workload execution time that at least one of write module 142 and load module 144 is in a stalled condition exceeding a first threshold, and power control logic 140 reduces the operating frequency of memory controller 130 upon the percentage of the total workload execution time that at least one of write module 142 and load module 144 is in a stalled condition being less than a second threshold. In a performance mode, power control logic 140 increases the operating frequency of memory controller 130 upon the percentage of the total workload execution time that at least one of write module 142 and load module 144 is in a stalled condition exceeding a first threshold, and power control logic 140 increases the operating frequency of compute unit 118 upon the percentage of the total workload execution time that at least one of write module 142 and load module 144 is in a stalled condition being less than a second threshold. In one embodiment, the first and second thresholds in the power savings and performance modes are based on the percentage of the total workload execution time that execution module 146 is in a stalled condition, as described herein with blocks 252, 264 of FIG. 7, for example. In one embodiment, at least one of the first and second thresholds is a predetermined percentage, as described herein with block 252 of FIG. 7, for example. As described herein, the repetitive workload may include multiple executed workloads that have similar workload characteristics.

Other suitable methods may be used to determine a memory-bound or compute-bound condition of GPU 112. As one example, a utilization may be determined for compute unit 118 and memory controller 130 based on the amount of GPUTime that the respective component is busy and not stalled. Power control logic 140 may then compare the utilization with one or more thresholds to determine the memory-bound and/or compute-bound conditions.

FIGS. 6 and 7 illustrate an exemplary detailed power management algorithm implemented by power control logic 140 in the power savings mode of operation. FIG. 6 illustrates a flow diagram 200 of an exemplary operation performed by power control logic 140 for activating compute units 118. FIG. 7 illustrates a flow diagram 250 of an exemplary operation performed by power control logic 140 for dynamically adjusting the power configuration of GPU 112 during runtime of computing system 100. Reference is made to computing system 100 of FIG. 2 throughout the description of FIGS. 6 and 7. The flow diagrams 200, 250 of FIGS. 6 and 7 are described as being performed by power control logic 140 of command/control processor 124 of GPU 112, although flow diagrams 200, 250 may alternatively be performed by power control logic 140 of power management controller 126 or of CPU 114 or by a combination of power control logic 140 of processor 124, controller 126, and/or CPU 114, as described herein.

Referring first to FIG. 6, the workload to be executed is identified at block 202. For example, command/control processor 124 receives an identifier (e.g., pointer) from CPU 114 during execution of a main program by CPU 114 that identifies a repetitive workload to be executed by GPU 112, as described herein. As described herein, the repetitive workload is operative to be executed by GPU 112 multiple times during system runtime. At block 204, power control logic 140 calculates the minimum number of compute units 118 required for execution of the workload. In one embodiment, the number of compute units 118 required for workload execution depends on the size and computational demands of the workload and the processing capacity of each compute unit 118. For example, a larger size or more compute-intensive workload requires more compute units 118. The minimum number of compute units 118 are determined at block 204 such that the likelihood of a performance loss (e.g., reduced execution speed) from the use of fewer than all available compute units 118 of GPU 112 is reduced, or such that only a negligible performance loss is likely to result. In the illustrated embodiment, command/control processor 124 calculates the total number of workgroups of the workload and the number of workgroups per compute unit 118. Command/control processor 124 determines the minimum number of compute units 118 needed for workload execution by dividing the total number of workgroups by the number of workgroups per compute unit 118. In one embodiment, command/control processor 124 determines the number of workgroups of the workload based on kernel parameters specified by a programmer. For example, a programmer specifies a kernel, which requires a certain amount of register space and local storage space, and a number of instances of the kernel (e.g., work items) to be executed. Based on the number of kernel instances that can be simultaneously executed within a compute unit 118 (subject to the available register and local memory capacity) as well as a fixed ceiling due to internal limits, the number of kernel instances per workload is determined. Command/control processor 124 determines the number of workgroups by dividing the total number of work-items/kernel instances by the workgroup size.

At block 206, if the minimum number of compute units 118 determined at block 204 is greater than or equal to the number of available compute units 118 of GPU 112, then at block 208 all of the available compute units 118 are implemented for the workload execution. If the required minimum number of compute units 118 determined at block 204 is less than the number of available compute units 118 of GPU 112 at block 206, then at block 210 power control logic 140 selects the minimum number of compute units 118 determined at block 204 for the workload execution. As such, at block 210 at least one of the available compute units 118 is not selected for execution of the workload. In one embodiment, the unselected compute units 118 at block 210 remain inactive during workload execution. In an alternative embodiment, one or more of the unselected compute units 118 at block 210 are utilized for execution of a second workload that is to be executed by GPU 112 in parallel with the execution of the first workload received at block 202.

At block 212, a first run (execution) of the workload is executed by GPU 112 at a baseline power configuration with the active compute units 118 selected at block 208 or 210. In one embodiment, the baseline power configuration specifies that each active compute unit 118 and memory controller 130 are operated at the full rated frequency and voltage. An exemplary rated frequency of compute units 118 is about 800 mega-hertz (MHz), and an exemplary rated frequency of memory controller 130 is about 1200 MHz, although GPU components may have any suitable frequencies depending on hardware configuration. At block 214, power control logic 140 determines if the total workload execution time (GPUTime) of the workload executed at block 212 is greater than or equal to a threshold execution time and chooses to either include the workload (block 216) or exclude the workload (block 218) for implementation with the power management method of FIG. 7, described herein. In particular, the threshold execution time of block 214 is predetermined such that the execution of a workload having a total execution time (GPUTime) that is greater than the threshold execution time is likely to result in GPU power savings when implemented with the power management method of FIG. 7. As such, at block 216 the method proceeds to FIG. 7 for implementation of the power savings.

However, the power management method of FIG. 7 is not implemented with a workload having a workload execution time (GPUTime) that is less than the threshold execution time. For example, a workload having a short execution time that is less than the threshold (e.g., a small subroutine, etc.) may execute too quickly for power control logic 140 to collect accurate performance data, or a power adjustment with the method of FIG. 7 for such a workload would result in minimal or negligible power savings. As such, the workload is executed at block 218 with the baseline power configuration. An exemplary threshold execution time is 0.25 milliseconds (ms), although any suitable threshold execution time may be implemented depending on system configuration.

In another embodiment, if the workload is to be executed by GPU 112 more than a predetermined number of times during runtime of the CPU program, the method proceeds to FIG. 7 at block 216 despite the workload execution time being less than the threshold execution time at block 214. For example, a workload that is repeatedly executed more than a threshold number of times may result in power savings from the power management method of FIG. 7 despite a short GPUTime per workload execution. The threshold number of workload executions required for implementation of the method of FIG. 7 may be any suitable number based on the expected power savings. In one embodiment, CPU 114 provides the number of executions required for the workload to GPU 112.

In another embodiment, the first execution of the workload at block 212 may be performed after the workload exclusion determination of block 214. In this embodiment, the workload execution time (GPUTime) used in block 214 is either estimated by power control logic 140 based on the workload size or is known from a prior execution of the workload. In the latter case, the GPUTime is stored in a memory, such as device memory 132, from a prior execution of the workload, such as from a previous execution of a program at CPU 114 that delegated the workload to GPU 112, for example.

Referring now to FIG. 7, power control logic 140 determines at block 252 whether compute units 118 of GPU 112 were memory-bound during the first execution of the workload at block 212 of FIG. 6 based on performance data (e.g., the performance counters described herein) monitored during workload execution. In particular, power control logic 140 determines whether compute units 118 were in a stalled condition during the first execution of the workload due to one or more compute units 118 waiting on memory controller 130 to complete read or write operations. Power control logic 140 analyzes the extent of the stalled condition to determine whether the power configuration of GPU 112 should be adjusted. In the illustrated embodiment, performance data associated with one compute unit 118 is monitored to determine the memory-bound condition, although multiple compute units 118 may be monitored.

In one exemplary embodiment, power control logic 140 detects and analyzes the stalled condition for one or more compute units 118 based on two performance characteristics: the performance or activity of write module 142 (FIG. 3) during workload execution, and the performance or activity of load module 144 (FIG. 3) as compared with the execution module 146 (FIG. 3) during workload execution. Regarding the performance of write module 142, power control logic 140 determines the percentage of the workload execution time (GPUTime) that write module 142 of compute unit 118 is stalled during workload execution (WriteModuleStalled). Power control logic 140 then compares the WriteModuleStalled percentage of compute unit 118 with a predetermined threshold percentage. If the WriteModuleStalled percentage of compute unit 118 exceeds the threshold percentage at block 252, then power control logic 140 determines that GPU 112 is memory-bound and is a candidate for power adjustment, and the method proceeds to block 254. An exemplary threshold percentage is 30%, although other suitable thresholds may be implemented.

In one embodiment, power control logic 140 also analyzes a stalled condition of compute unit 118 at block 252 based on a comparison of the processing activity of load module 144 with a second threshold that is based on the processing activity of execution module 146 of compute unit 118. In particular, when load module 144 of the monitored compute unit 118 issues read requests to memory controller 130, and when compute unit 118 must wait on memory controller 130 to return data before execution module 146 can execute the data and before the load module 144 can issue more read requests, then compute unit 118 is determined to be memory-bound. To determine this memory-bound condition, power control logic 140 compares the percentage of GPUTime that execution module 146 is busy (ExecModuleBusy) with the percentage of GPUTime that load module 144 is busy (LoadModuleBusy) and with the percentage of GPUTime that load module 144 is stalled (LoadModuleStalled). If the LoadModuleBusy and the LoadModuleStalled percentages both exceed the threshold set by the ExecModuleBusy percentage by at least a predetermined amount, then power control logic 140 determines that GPU 112 is memory-bound, and the method proceeds to block 254. In other words, if load module 144 is both busy and stalled longer than the time that execution module 146 is busy by a predetermined factor, then GPU 112 is determined to be memory-bound. Other performance data and metrics may be used to determine that one or more compute units 118 are memory-bound, such as a utilization percentage of the write/load modules 142, 144 and/or memory controller 130.

Upon determining that compute unit 118 is memory-bound at block 252, power control logic 140 decreases the operating frequency (F_{CU}) of the active compute units 118 by a predetermined increment (e.g., 100 MHz or another suitable frequency increment) at block 254 prior to the next execution of the workload. In some embodiments, the voltage is also decreased. Such a reduction in operating frequency serves to reduce power consumption by GPU 112 during future executions of the workload. In one embodiment, the operating frequency of each active compute unit 118 is decreased by the same amount in order to facilitate synchronized communication between compute units 118. At block 256, the next run of the workload is executed by GPU 112, and the performance of compute units 118 and memory controller 130 is again monitored. At blocks 258 and 260, if the frequency reduction at block 254 resulted in a performance loss that exceeds or equals a threshold performance loss, then the previous power configuration (i.e., the frequency and voltage of compute units 118 and memory controller 130) prior to the frequency adjustment of block 254 is implemented. At block 262, the remainder of the workload repetition is executed using the previous power configuration. If at block 258 the resulting performance loss is less than the threshold performance loss, then the method returns to block 254 to again decrease the operating frequency of the compute units 118 by the predetermined amount. The method continues in the loop of blocks 254-258 to step-reduce the operating frequency of the compute units 118 and to monitor the performance loss until the performance loss exceeds the threshold performance loss, upon which the power configuration before the last frequency adjustment is implemented for the remainder of the workload repetition (blocks 260 and 262). An exemplary threshold performance loss for block 258 is a 3% performance loss, although any suitable threshold performance loss may be implemented. In one embodiment, performance loss is measured by comparing the execution time (measured by cycle-count performance counters, for example) of the different runs of the workload.

Upon determining at block 252 that compute units 118 are not memory-bound (based on the thresholds set in block 252), the method proceeds to block 264 to determine whether compute units 118 are compute-bound based on the monitored performance data (e.g., the performance counters described herein). In particular, power control logic 140 determines whether memory controller 130 was in a stalled condition or is underutilized during the first execution of the workload due to memory controller 130 waiting on one or more compute units 118 to complete an operation. Power control logic 140 analyzes the extent of the underutilization of memory controller 130 to determine whether the power configuration of GPU 112 should be adjusted. In the illustrated embodiment, performance data associated with one compute unit 118 is monitored to determine the compute-bound condition, although multiple compute units 118 and/or memory controller 130 may be monitored.

In the illustrated embodiment, power control logic 140 detects and analyzes the compute-bound condition based on the performance or activity of the load module 144 (FIG. 3) as compared with a threshold determined by the activity of the execution module 146 (FIG. 3) during workload execution. In particular, if the percentage of time that load module 144 is busy (LoadModuleBusy) and the percentage of time that load module 144 is stalled (LoadModuleStalled) are about the same as the percentage of time that execution module 146 is busy (ExecModuleBusy), then compute units 118 are determined to not be compute-bound at block 264 and the current power configuration is determined to be efficient. In other words, power control logic 140 determines that the active compute units 118 are operating at or near capacity and the memory bandwidth between memory controller 130 and system memory 136 is at or near capacity. As such, the remainder of the workload repetition is executed at the current operational frequency of compute units 118 (F_{CU}) and memory controller 130 (F_{MEM}) at block 266.

If the LoadModuleBusy and the LoadModuleStalled percentages are both less than the ExecModuleBusy percentage by at least a predetermined amount, then power control logic 140 determines that GPU 112 is compute-bound, and the method proceeds to block 268. In other words, if load module 144 is both busy and stalled for less than the time that execution module 146 is busy by a predetermined factor, then GPU 112 is determined to be compute-bound and to require power adjustment. Other performance data and metrics may be used to determine that one or more compute units 118 are compute-bound, such as a utilization percentage of compute units 118 and/or memory controller 130.

At block 268, power control logic 140 decreases the operating frequency of memory controller 130 (F_{MEM}) by a predetermined increment (e.g., 100 MHz or another suitable frequency increment) before the next execution of the workload. By reducing the operating frequency F_{MEM}, the power consumption by memory controller 130 during future workload executions is reduced. In one embodiment with multiple memory controllers 130, the operating frequency of each memory controller 130 is decreased by the same incremental amount to facilitate synchronized memory communication.

At block 270, the next run of the workload is executed by GPU 112, and the performance of one or more compute units 118 and memory controller 130 is again monitored. At blocks 272 and 260, if the frequency reduction at block 268 resulted in a performance loss that exceeds or equals the threshold performance loss (described herein with respect to block 258), then the previous power configuration (i.e., the frequency and voltage of compute units 118 and memory controller 130) prior to the frequency adjustment of block 268 is implemented. At block 262, the remainder of the workload repetition is executed using the previous power configuration. If at block 272 the resulting performance loss is less than the threshold performance loss, then the method returns to block 268 to again decrease the operating frequency of the memory controller 130 by the predetermined amount. The method continues in the loop of blocks 268-272 to step-reduce the operating frequency of memory controller 130 and to monitor the performance loss until the performance loss exceeds the threshold performance loss, upon which the power configuration before the last frequency adjustment is implemented for the remainder of the workload repetition (blocks 260 and 262).

FIGS. 8 and 9 illustrate an exemplary power management algorithm implemented by power control logic 140 in the performance mode of operation. Reference is made to computing system 100 of FIG. 2 throughout the description of FIGS. 8 and 9. FIG. 8 illustrates a flow diagram 300 of an exemplary operation performed by power control logic 140 for activating compute units 118 in the performance mode. The flow diagram 300 of FIG. 8 is described as being performed by power control logic 140 of command/control processor 124 of GPU 112, although flow diagram 300 may alternatively be performed by power control logic 140 of power management controller 126 or of CPU 114 or by a combination of power control logic 140 of processor 124, controller 126, and/or CPU 114, as described herein.

Blocks 302-316 of FIG. 8 are similar to blocks 202-216 of FIG. 6. As such, the description of blocks 202-216 of FIG. 6 also applies to corresponding blocks 302-316 of FIG. 8. However, the flow diagram 300 of FIG. 8 deviates from the flow diagram 200 of FIG. 6 starting at block 318. Upon the workload execution time (GPUTime) being less than the threshold execution time at block 314, the method proceeds to block 318 to determine whether all available compute units 118 are being used, based on the determinations at blocks 304 and 306. If all available compute units 118 are being used for workload execution at block 318, then the workload is executed at blocks 320 and 324 with the baseline power configuration. If less than all of the available compute units 118 are being used for workload execution at block 318, then the operating frequency of both the active compute units 118 (F_{CU}) and the memory controller 130 (F_{MEM}) are boosted by a suitable predetermined amount based on the number of inactive compute units 118. For example, for each compute unit 118 that is available but inactive, additional power that is normally consumed by that inactive compute unit 118 is available for consumption by the active compute units 118 and memory controller 130. As such, additional power is available for boosting F_{CU} and F_{MEM}. In one embodiment, F_{CU} and F_{MEM} are boosted such that the operating temperature of GPU components remains within a temperature limit. Upon boosting the operating frequencies F_{CU} and F_{MEM} at block 322, the remainder of the workload repetition is executed at the boosted operating frequencies.

As described herein with respect to FIGS. 6 and 7, in another embodiment, the first execution of the workload at block 312 may be performed after the workload exclusion determination of block 314. In this embodiment, the workload execution time (GPUTime) used in block 314 is either estimated by power control logic 140 based on the workload size or is known from a prior execution of the workload. In the latter case, the GPUTime is stored in a memory, such as device memory 132, from a prior execution of the workload, such as from a previous execution of a program at CPU 114 that delegated the workload to GPU 112, for example.

FIG. 9 illustrates a flow diagram 350 of an exemplary operation performed by power control logic 140 in the performance mode of operation for dynamically adjusting the power configuration of GPU 112 during runtime of computing system 100. The flow diagram 350 of FIG. 9 may be performed by power control logic 140 of power management controller 126, of command/control processor 124, and/or of CPU 114, as described herein.

Power control logic 140 determines whether GPU 112 is compute-bound or memory-bound at respective blocks 352 and 364 of FIG. 9 as described herein with respective blocks 252 and 264 of FIG. 7. Upon a determination that GPU 112 is memory-bound at block 352, power control logic 140 increases F_{MEM} by a predetermined increment (e.g., 100 MHz or another suitable frequency increment) at block 354 if possible, i.e., without violating a power constraint or a temperature constraint of GPU 112. The power constraint is based on the maximum power level that is available at GPU 112. Such an increase in F_{MEM} prior to the next workload execution serves to increase the speed of communication between memory controller 130 and system memory 36 to thereby reduce the bottleneck in memory bandwidth identified with block 352. If the power and temperature constraints do not allow F_{MEM} to be increased at block 354, then the operating frequency of compute units 118 (F_{CU}) is decreased by a predetermined increment (e.g., 100 MHz or another suitable frequency increment) at block 354. Such a reduction in F_{CU} serves to reduce power consumption by GPU 112 such that the saved power resulting from the reduction can be allocated to other portions of GPU 112, such as to memory controller 130, as described herein.

At block 356, the next run of the workload is executed by GPU 112, and the performance of one or more compute units 118 and memory controller 130 is again monitored. At blocks 358 and 360, if the frequency adjustment made at block 354 did not improve the performance of GPU 112 during workload execution, then the previous power configuration (i.e., the frequency and voltage of compute units 118 and memory controller 130) prior to the frequency adjustment of block 354 is implemented. At block 362, the remainder of the workload repetition is executed using the previous power configuration.

If at block 358 the performance of GPU 112 is improved due to the frequency adjustment at block 354, then the method returns to block 354 to again attempt to increase the memory frequency F_{MEM} by the predetermined increment. When F_{CU} is reduced during the prior execution of block 354, more power is available for increasing F_{MEM} at the following execution of block 354. The method continues in the loop of blocks 354-358 to adjust the operating frequency of the compute units 118 and memory controller 130 until the workload performance is no longer improved, upon which the power configuration before the last frequency adjustment is implemented for the remainder of the workload repetition (blocks 360 and 362).

Upon determining at block 352 that GPU 112 is not memory-bound (based on the thresholds set in block 352), the method proceeds to block 364 to determine whether one or more compute units 118 are compute-bound, as described herein with respect to block 264 of FIG. 7. If GPU 112 is not compute-bound at block 364 of FIG. 9, the remainder of the workload repetition is executed at the current operational frequency of the compute units 118 (F_{CU}) and memory controller 130 (F_{MEM}) at block 366, as described herein with respect to block 266 of FIG. 7.

If GPU 112 is determined to be compute-bound at block 364 of FIG. 9, power control logic 140 increases F_{CU} by a predetermined increment (e.g., 100 MHz or another suitable frequency increment) at block 368 if possible, i.e., without violating the power constraint or the temperature constraint of GPU 112. Such an increase in F_{CU} prior to the next workload execution serves to reduce the computational bottleneck in compute units 118 identified with block 364. If the power and temperature constraints do not allow F_{CU} to be increased at block 368, then the operating frequency of memory controller 130 (F_{MEM}) is decreased by a predetermined increment (e.g., 100 MHz or another suitable frequency increment) at block 368 prior to the next execution of the workload. Such a reduction in F_{MEM} serves to reduce power consumption by GPU 112 such that the saved power can be allocated to other portions of GPU 112, such as to compute units 118, as described below.

At block 370, the next run of the workload is executed by GPU 112, and the performance of one or more compute units 118 and memory controller 130 is again monitored. At blocks 372 and 360, if the frequency adjustment made at block 368 did not improve the performance of GPU 112 during workload execution, then the previous power configuration (i.e., the frequency and voltage of compute units 118 and memory controller 130) prior to the frequency adjustment of block 368 is implemented. At block 362, the remainder of the workload repetition is executed using the previous power configuration.

If at block 372 the performance of GPU 112 is improved due to the frequency adjustment at block 368, then the method returns to block 368 to again attempt to increase the compute unit frequency F_{CU} by the predetermined increment. By reducing F_{MEM} during the prior execution of block 368, more power is available for increasing F_{CU} at the following execution of block 368. The method continues in the loop of blocks 368-372 to adjust the operating frequency of the compute units 118 and/or memory controller 130 until the workload performance is no longer improved, upon which the power configuration before the last frequency adjustment is implemented for the remainder of the workload repetition (blocks 360 and 362).

As described herein, the amount of frequency increase implemented in the methods of FIGS. 4-9 is further limited by a temperature constraint, i.e., the temperature limits of each component of GPU 112. In one embodiment, GPU 112 includes multiple temperature sensors that provide feedback to power control logic 140 indicating the temperature of GPU components during workload execution. Power control logic 140 is operative to reduce an operating frequency (e.g., F_{CU} or F_{MEM}) of GPU components upon the temperature limits being exceeded or in anticipation of the temperature limits being exceeded with the current power configuration.

While power control logic 140 has been described for use with a GPU 112, other suitable processors or processing devices may be used with power control logic 140. For example, power control logic 140 may be implemented for managing power consumption in a digital signal processor, another mini-core accelerator, a CPU 112, or any other suitable processor. Further, power control logic 140 may be implemented with the processing of graphical data with GPU 112.

Among other advantages, the method and system of the present disclosure provides adaptive power management control of one or more processing devices during runtime based on monitored characteristics associated with the execution of a repetitive workload, thereby serving to minimize power consumption while minimally affecting performance or to maximize performance under a power constraint. Other advantages will be recognized by those of ordinary skill in the art.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

What is claimed is:

1. A power management method for at least one processor having a compute unit and a memory controller, the method comprising:
monitoring, by power control logic of the at least one processor, performance data associated with each of a plurality of executions of a repetitive workload by the at least one processor; and
adjusting, by the power control logic following an execution of the repetitive workload, an operating frequency of at least one of the compute unit and the memory controller upon a determination by the power control logic that the at least one processor is at least one of compute-bound and memory-bound based on monitored performance data associated with the execution of the repetitive workload.

2. The method of claim 1, wherein the monitoring includes receiving an identifier associated with the repetitive workload, further comprising executing the repetitive workload upon each receipt of the identifier.

3. The method of claim 1, wherein the determination includes
determining a total workload execution time associated with the execution of the repetitive workload,
determining a percentage of the total workload execution time that at least one of a load module and a write module of the compute unit is in a stalled condition, the load module being configured to load data from the memory controller and the write module being configured to write data to the memory controller, and
comparing the percentage of the total workload execution time to a threshold percentage to determine that the at least one processor is at least one of compute-bound and memory-bound.

4. The method of claim 1, wherein the determination includes determining that the at least one processor is compute-bound based on the memory controller having unused memory bandwidth during the execution of the repetitive workload and determining that the at least one processor is memory-bound based on the compute unit being in a stalled condition during the execution of the repetitive workload.

5. The method of claim 4, wherein the adjusting includes reducing the operating frequency of the compute unit upon a determination that the at least one processor is memory-bound during the execution of the workload and reducing the operating frequency of the memory controller upon a determination that the at least one processor is compute-bound during the execution of the workload.

6. The method of claim 4, wherein the adjusting includes increasing the operating frequency of the memory controller upon a determination that the at least one processor is memory-bound during the execution of the workload and increasing the operating frequency of the compute unit upon a determination that the at least one processor is compute-bound during the execution of the workload.

7. The method of claim 1, further comprising
receiving a workload having an execution time that is less than a threshold execution time, and
executing the workload at a maximum operating frequency of the compute unit and the memory controller.

8. The method of claim 1, wherein the repetitive workload comprises at least one of a workload configured for multiple executions by the at least one processor and multiple workloads having similar workload characteristics.

9. The method of claim 1, wherein the adjusting, by the power control logic, further comprises adjusting the operation of at least one of the compute unit, the memory controller, and the memory by employing one or more of the following: clock gating, power gating, power sloshing, and temperature sensing.

10. A power management method for at least one processor having a compute unit and a memory controller, the method comprising:
monitoring, by power control logic of the at least one processor, performance data associated with each of a plurality of executions of a repetitive workload by the at least one processor;
determining, by the power control logic, a percentage of a total workload execution time of a first execution of the repetitive workload that at least one of a write module, a load module, and an execution module of the compute unit is in a stalled condition based on performance data associated with the first execution of the repetitive workload; and
adjusting, by the power control logic prior to a second execution of the repetitive workload, an operating frequency of at least one of the compute unit and the memory controller based on a comparison of the determined percentage with a threshold percentage.

11. The method of claim 10, wherein the adjusting includes reducing the operating frequency of the compute unit upon the percentage of the total workload execution time that at least one of the write module and the load module is in a stalled condition exceeding a first threshold and reducing the operating frequency of the memory controller upon the percentage of the total workload execution time that at least one of the write module and the load module is in a stalled condition being less than a second threshold.

12. The method of claim 11, wherein the first and second thresholds are based on the percentage of the total workload execution time that the execution module is in a stalled condition.

13. The method of claim 10, wherein the adjusting includes increasing the operating frequency of the memory controller upon the percentage of the total workload execution time that at least one of the write module and the load module is in a stalled condition exceeding a first threshold and increasing the operating frequency of the compute unit upon the percentage of the total workload execution time that at least one of the write module and the load module is in a stalled condition being less than a second threshold.

14. The method of claim 13, wherein the operating frequency of the at least one of the compute unit and the memory controller is increased based on a total power consumption of the at least one processing device during the first execution of the workload being less than a maximum power consumption threshold.

15. The method of claim 10, wherein the load module is configured to load data from the memory controller, the write module is configured to write data to the memory controller, and the execution module is configured to perform computations associated with the execution of the repetitive workload.

16. The method of claim 10, wherein the operating frequency of the at least one of the compute unit and the memory controller is adjusted by a predetermined increment following each of a plurality of successive executions of the repetitive workload based on the monitored performance data.

17. The method of claim 10, further including
detecting a performance loss of the at least processor following the second execution of the repetitive workload with the adjusted operational frequency based on the monitored performance data, and
restoring a previous operating frequency of the at least one of the compute unit and the memory controller upon the detected performance loss exceeding a performance loss threshold.

18. The method of claim 10, wherein the at least one processor includes a plurality of compute units, the method further comprising determining, by the power control logic, a minimum number of compute units of the at least one processor required for an execution of the repetitive workload based on a processing capacity of each compute unit, each compute unit being operative to execute at least one processing thread of the repetitive workload.

19. An integrated circuit comprising:
at least one processor including a memory controller and a compute unit in communication with the memory controller, the at least one processor having power control logic operative to
monitor performance data associated with each of a plurality of executions of a repetitive workload by the at least one processor, and
adjust, following an execution of the repetitive workload by the at least one processor, an operating frequency of at least one of the compute unit and the memory controller upon a determination by the power control logic that the at least one processor is at least one of compute-bound and memory-bound based on monitored performance data associated with the execution of the repetitive workload.

20. The integrated circuit of claim 19, wherein the power control logic is further operative to receive an identifier associated with the repetitive workload, wherein the at least one processor executes the repetitive workload upon each receipt of the identifier.

21. The integrated circuit of claim 19, wherein the power control logic determines that the at least one processor is compute-bound based on the memory controller having unused memory bandwidth during the execution of the repetitive workload and determines that the at least one processor is memory-bound based on the compute unit being in a stalled condition during the execution of the repetitive workload.

22. The integrated circuit of claim 21, wherein the power control logic is operative to reduce the operating frequency of the compute unit upon a determination that the at least one processor is memory-bound during the execution of the workload and to reduce the operating frequency of the memory controller upon a determination that the at least one processor is compute-bound during the execution of the workload.

23. The integrated circuit of claim 21, wherein the power control logic is operative to increase the operating frequency of the memory controller upon a determination that the at least one processor is memory-bound during the execution of the workload and to increase the operating frequency of the compute unit upon a determination that the at least one processor is compute-bound during the execution of the workload.

24. The integrated circuit of claim 19, wherein the at least one processor is in communication with a second processor and a system memory, the memory controller is operative to access the system memory, and the second processor is operative to execute a program and to offload the repetitive workload for execution by the at least one processor, wherein the repetitive workload is associated with the program.

25. An integrated circuit comprising:
at least one processor including a memory controller and a compute unit in communication with the memory controller, the compute unit including a write module, a load module, and an execution module, the at least one processor having power control logic operative to
monitor performance data associated with each of a plurality of executions of a repetitive workload by the at least one processor,
determine a percentage of a total workload execution time of a first execution of the repetitive workload that at least one of the write module, the load module, and the execution module of the compute unit is in a stalled condition based on performance data associated with the first execution of the repetitive workload, and
adjust, prior to a second execution of the repetitive workload, an operating frequency of at least one of the compute unit and the memory controller based on a comparison of the determined percentage with a threshold percentage.

26. The integrated circuit of claim 25, wherein the power control logic is operative to reduce the operating frequency of the compute unit upon the percentage of the total workload execution time that at least one of the write module and the load module is in a stalled condition exceeding a first threshold and to reduce the operating frequency of the memory controller upon the percentage of the total workload execution time that at least one of the write module and the load module is in a stalled condition being less than a second threshold.

27. The integrated circuit of claim 25, wherein the power control logic is operative to increase the operating frequency of the memory controller upon the percentage of the total workload execution time that at least one of the write module and the load module is in a stalled condition exceeding a first threshold and to increase the operating frequency of the compute unit upon the percentage of the total workload execution time that at least one of the write module and the load module is in a stalled condition being less than a second threshold.

28. The method of claim 27, wherein the first and second thresholds are based on the percentage of the total workload execution time that the execution module is in a stalled condition.

29. The method of claim 27, wherein the power control logic increases the operating frequency of the at least one of the compute unit and the memory controller based on a total power consumption of the at least one processor during the first execution of the workload being less than a maximum power consumption threshold.

30. The method of claim 25, wherein the load module is configured to load data from the memory controller, the write module is configured to write data to the memory controller, and the execution module is configured to perform computations associated with the execution of the repetitive workload.

31. The integrated circuit of claim 25, wherein the power control logic is further operative to
detect a performance loss of the at least processor following the second execution of the repetitive workload with the adjusted operational frequency based on the monitored performance data, and
restore a previous operating frequency of the at least one of the compute unit and the memory controller upon the detected performance loss exceeding a performance loss threshold.

32. A non-transitory computer-readable medium comprising:
executable instructions such that when executed by at least one processor cause the at least one processor to:
monitor performance data associated with each of a plurality of executions of a repetitive workload by the at least one processor, and
adjust, following an execution of the repetitive workload by the at least one processor, an operating frequency of at least one of the compute unit and the memory controller upon a determination by the power control logic that the at least one processor is at least one of compute-bound and memory-bound based on monitored performance data associated with the execution of the repetitive workload.

33. The non-transitory computer-readable medium of claim 32, wherein the executable instructions further cause the at least one processor to:
receive an identifier associated with the repetitive workload, and
execute the repetitive workload upon each receipt of the identifier.

34. The non-transitory computer-readable medium of claim 32, wherein the executable instructions further cause the at least one processor to:
determine that the at least one processor is compute-bound based on the memory controller having unused memory bandwidth during the execution of the repetitive workload, and
determine that the at least one processor is memory-bound based on the compute unit being in a stalled condition during the execution of the repetitive workload.

35. The non-transitory computer-readable medium of claim 34, wherein the executable instructions further cause the at least one processor to:
reduce the operating frequency of the compute unit upon a determination that the at least one processor is memory-bound during the execution of the workload, and
reduce the operating frequency of the memory controller upon a determination that the at least one processor is compute-bound during the execution of the workload.

36. The non-transitory computer-readable medium of claim 34, wherein the executable instructions further cause the at least one processor to:
increase the operating frequency of the memory controller upon a determination that the at least one processor is memory-bound during the execution of the workload, and
increase the operating frequency of the compute unit upon a determination that the at least one processor is compute-bound during the execution of the workload.

37. An apparatus comprising:
a first processor operative to execute a program and to offload a repetitive workload associated with the program for execution by another processor; and
a second processor in communication with the first processor and operative to execute the repetitive workload, the second processor including a memory controller and a compute unit in communication with the memory controller, the compute unit including a write module, a load module, and an execution module, the second processor including power control logic operative to
monitor performance data associated with each of a plurality of executions of a repetitive workload by the at least one processor,
determine a percentage of a total workload execution time of a first execution of the repetitive workload that at least one of the write module, the load module, and the execution module of the compute unit is in a stalled condition based on performance data associated with the first execution of the repetitive workload, and
adjust, prior to a second execution of the repetitive workload, an operating frequency of at least one of the compute unit and the memory controller based on a comparison of the determined percentage with a threshold percentage.

38. The apparatus of claim 37, wherein the power control logic of the second processor is operative to reduce the operating frequency of the compute unit upon the percentage of the total workload execution time that at least one of the write module and the load module is in a stalled condition exceeding a first threshold and to reduce the operating frequency of the memory controller upon the percentage of the total workload execution time that at least one of the write module and the load module is in a stalled condition being less than a second threshold.

39. The method of claim 38, wherein the first and second thresholds are based on the percentage of the total workload execution time that the execution module is in a stalled condition.

40. The apparatus of claim 37, wherein the power control logic of the second processor is operative to increase the operating frequency of the memory controller upon the percentage of the total workload execution time that at least one of the write module and the load module is in a stalled condition exceeding a first threshold and to increase the operating frequency of the compute unit upon the percentage of the total workload execution time that at least one of the write module and the load module is in a stalled condition being less than a second threshold.

41. The apparatus of claim 40, wherein the power control logic of the second processor increases the operating frequency of the at least one of the compute unit and the memory controller based on a total power consumption of the second processor during the first execution of the workload being less than a maximum power consumption threshold.

42. The apparatus of claim 37, wherein the load module is configured to load data from the memory controller, the write module is configured to write data to the memory controller, and the execution module is configured to perform computations associated with the execution of the repetitive workload.

43. The apparatus of claim 37, wherein the power control logic of the second processor is further operative to
detect a performance loss of the second processor following the second execution of the repetitive workload with the adjusted operational frequency based on the monitored performance data, and
restore a previous operating frequency of the at least one of the compute unit and the memory controller upon the detected performance loss exceeding a performance loss threshold.
